(19) United States
(12) Patent Application Publication
(10) Pub. No.: US 2005/0212166 A1
(43) Pub. Date: Sep. 29, 2005

(54) Apparatus for processing fiber-reinforced composites using fiber mat and its manufacture

(76) Inventors: Duck-Hyun Seo, Gyungi-do (KR); Hyeong-Ki Choi, Seoul (KR); Yong-Moo Lee, Seoul (KR)

Correspondence Address: DILWORTH & BARRESE, LLP, 333 EARLE OVINGTON BLVD., UNIONDALE, NY, 11553, US

(21) Appl. No.: 10/511,014

(22) PCT Filed: Apr. 11, 2002
(86) PCT No.: PCT/KR02/00658

§ 371 Date: Oct. 8, 2004

(51) Int. Cl. B29B 11/16

(52) U.S. Cl. 264/147; 264/171.1; 425/382 R; 425/363

(57) ABSTRACT

Disclosed is a method of manufacturing a multifunctional fiber-reinforced composite using a composite fiber mat and an apparatus for manufacturing the same, in which at least two types of thermoplastic fiber and reinforcing fiber are used to manufacture a composite mat or a composite sheet, as well as a light adiabatic sheet having cells foamed due to inherent resilience of the reinforcing fiber while the composite sheet is compressed by rollers. The method includes fibrillating and combining the thermoplastic fiber and the reinforcing fiber to form the composite mat, dispersing and volatilizing the composite mat, and needle-punching the dispersed and volatilized composite mat. Then, the composite mat is subjected to preheating in a preheating zone, melting, compressing and molding in a compressing zone, and cooling in a cooling zone, to yield the composite sheet. Selectively, the composite sheet is re-heated to obtain a pseudo-foamed composite sheet by inherent resilience of the fiber.

### TECHNICAL FIELD

The present invention relates to methods of manufacturing a fiber-reinforced composite using a fiber mat for use in production of high performance fiber-reinforced composite articles, and apparatus for manufacturing the same.

In particular, the present invention is directed to a method of manufacturing a multifunctional fiber-reinforced composite by subjecting at least two types of long and short fibers combined and matted together to heating and compressing or cooling, characterized in that at least two types of thermoplastic resin fibers selectively containing any one type of inorganic reinforcing fiber are used to manufacture a composite mat or a composite sheet, as well as a light adiabatic foamed composite sheet having cells formed due to inherent resilience of the non-melted fiber or the reinforcing fiber while the composite sheet is compressed by rollers even though a chemical foaming agent is not additionally used; and an apparatus for manufacturing the same.

### BACKGROUND ART

As well known to those skilled in the art, so called fiber-reinforced composites which can exhibit new functions by combining and matting at least two different types of materials have been developed to have light weight, high specific strength and high specific modulus of elasticity with enhanced mechanical properties. Thus, the fiber-reinforced composites have been widely applied to various industrial fields requiring strength, stiffness and durability, such as structural parts of aircrafts, ships and automobiles, and electric and electronic parts.

As representative examples of the composites, there are proposed a fiber-reinforced polymer (FRP) composite comprising a thermosetting unsaturated polyester resin reinforced with a glass fiber, and a fiber-reinforced thermoplastic polymer (FRTP) composite.

The FRP composite has superior functions to metal, and can be used to the above applications. In particular, the FRP composite may function as an elastic material having high elastic modulus upon unidirectional molding.

However, the FRP composite is poor in physical properties including impact resistance and fracture toughness, and is disadvantageous in that it is usable under only limited conditions and it is not recyclable.

However, the FRTP composite avoids the above problems of the FRP composite, and is further capable of being substituted for metals in automobile parts.

For example, the FRTP composite, which is mainly used for interior finishes and non-structural parts in the automobiles, is applicable to structures such as chassis requiring impact resistance and high strength, and diverse exterior finishes. Further, compared to the FRP composite, the FRTP composite may be subjected to a stamping molding process similar to a molding process of metals. Therefore, the FRTP composite is high in productivity and is more freely designed than metals, resulting in that it is increasingly applied to various industrial fields.

Accordingly, the FRTP composite should be prepared as a stampable planar sheet, suitable for use in the molding process of various molded articles. For this, typically, the reinforcing fiber is combined with powder or pellet type themoplastic resin as a matrix resin, and heated and molded. But, in such a case, it is difficult to uniformly combine two materials due to their different material phases. As well, after being combined, the resin powders or pellets may be easily separated from the reinforcing fiber during a plurality of treatment processes. Thus the reinforcing fiber is not evenly dispersed in the matrix resin, whereby end products requiring consistent quality are hard to manufacture.

In connection with a method of manufacturing the stampable sheet, Korean Patent No. 10-296229, which is patented by the present inventors, discloses a method of manufacturing fiber-reinforced composites with enhanced performance, and an apparatus for manufacturing the same. In the above patent, a thermoplastic resin fiber as the matrix resin is combined with the reinforcing fiber by centrifugal force to manufacture a composite mat having randomly oriented matrix fiber, which is melted and compressed by means of the above apparatus having a plurality of heating rollers and cooling rollers. Also, while angles between shafts of rollers are changed, the melted matrix resin is evenly distributed and impregnated into the reinforcing fiber. Thereby, interfacial adhesion between the matrix and the reinforcing fiber is increased, to continuously provide the stampable fiber-reinforced composite sheet having excellent physical properties and uniform thickness with superior surface smoothness. In particular, with the intention of supplementing insufficient stiffness due to only the randomly oriented reinforcing fiber, a top surface, a bottom surface and lateral surfaces of the composite mat are laminated with a unidirectional reinforcing fiber by use of the manufacturing apparatus of the stampable sheet, thereby the fiber-reinforced composite having improved properties.

The present invention has further improved the above patent, and is based on technical concepts of “an apparatus for manufacturing a stampable sheet of a fiber-reinforced composite” of Korean Patent No. 10-173440. In this patent, high performance of a foamed composite which is advantageous in terms of uniform thickness and high surface smoothness can be provided by optionally controlling a melt flow direction of heat hysteresis factor in the melted resin.

In this regard, Japanese Patent Laid-open Publication No. Hei. 647737 discloses an apparatus for manufacturing a stampled sheet, comprising a resin extruder to compress/feed a melted polypropylene resin between a continuous glass fiber sheet and a polypropylene sheet having dispersed short glass fibers; a returning conveyor belt for vertically compressing and laminating the polypropylene sheet, the melted polypropylene resin and the continuous glass fiber sheet while they are conveyed at the same time; a heating furnace for impregnating the melted polypropylene into the continuous glass fiber sheet by heating the laminated sheets, to form an integrally laminated sheet; and a cooling furnace for cooling the heated sheet. As mentioned above, when the melted polypropylene is extruded into the sheets, the resin extruder is additionally required. Further, it is difficult to uniformly coat the melted resin onto the total surface of the continuous sheet.

Neither optional control of thickness of the sheet by means of the conveyor belt nor densely bonded structure and uniform surface smoothness of end products are ensured. In addition, the heating furnace and the cooling furnace are chamber-shaped, and are not provided with an additional unit for use in re-controlling the thickness of the product upon heating and cooling.

Further, in Japanese Patent Laid-open Publication No. Hei. 5-285947, there is disclosed an apparatus for manufacturing a fiber-reinforced composite sheet, comprising three hoppers for respectively receiving thermoplastic resin particles, reinforcing short fiber and glass blown (hollow particles); a dispersing container for dispersing the materials fed from each hopper into liquid; a headbox for removing water from the dispersed liquid; a mesh forming paper web thereon with moving in the headbox; a hot air dryer for drying the web; and a continuous press. However, the above patent suffers from difficult handling of the materials due to use of particles or short fibers. Also, continuous fibers or long fibers cannot be handled by use of the apparatus. Further, dust may be generated and work environment becomes very poor. Since the materials are separately fed to the apparatus and dispersed therein, an additional dehydrating unit is required, whereby water contamination may occur.

Furthermore, in Japanese Patent Laid-open Publication No. Hei. 5-16137, there is disclosed an apparatus for manufacturing a fiber-reinforced composite sheet, comprising a flow layer unit having separately formed upper, medium and lower layers to prepare a resin-attached fiber bundle; upper and lower rotary cutters for cutting the fiber bundle; a continuous belt for conveying the cut resin-attached fiber bundle attached to a top and a bottom of a continuous thick fabric-attached fiber bundle fed from the medium flow layer unit; a heating unit; and a cooling unit. However, the heating unit adopts an electric heating system or hot air circulation system, in which shafts of heating rollers are fixed. Thus, melt flow direction of heat hysteresis factor of the melted thermoplastic resin cannot be changed. Thereby, it is impossible to achieve uniform impregnation of the melted resin. Further, difficult control of sheet tension results in non-uniform thickness and surface smoothness of the composite sheet. In addition, because of the cooling unit adopting an air blowing system or a cooling system by fixed guide rollers, resultant thickness of the heated sheet is difficult to control.

### DISCLOSURE OF THE INVENTION

Therefore, it is an object of the present invention to provide a method of manufacturing a multifunctional fiber-reinforced composite through processes of heating and compressing or cooling of a composite mat obtained by uniformly combining and matting at least two types of a thermoplastic resin fiber as a matrix and a reinforcing fiber, characterized in that melt flow direction of heat hysteresis factor of the melted resin is optionally varied to manufacture a foamed composite mat or sheet having uniform thickness and surface smoothness, which is applicable in various industrial fields.

It is another object of the present invention to provide an apparatus for manufacturing a fiber-reinforced composite.

To achieve the above objects, the present invention provides a method of manufacturing a fiber-reinforced composite having high strength by heating and extruding a composite mat comprising a thermoplastic fiber as a matrix resin and a reinforcing fiber combined and matted together, the method comprising the steps of fibrillating the thermoplastic and reinforcing fibers, matting the fibrillated thermoplastic fiber and reinforcing fiber to prepare a thermoplastic fiber-fused composite mat, preparing a laminated composite mat by sequentially laminating various sheets on a top surface, a bottom surface and lateral surfaces of the composite mat, and heating the laminated composite mat to prepare a high performance fiber-reinforced composite sheet having foamed cells due to inherent resilience of the reinforcing fiber.

In addition, the present invention provides an apparatus for manufacturing a fiber-reinforced composite having high strength, comprising a fiber fibrillating unit of the thermoplastic and reinforcing fibers, a composite mat preparing unit for fusing the thermoplastic fiber by processing the fibrillated fibers, a laminated composite mat preparing unit for sequentially laminating a top surface, a bottom surface and lateral surfaces of the composite mat with various sheets, and a fiber-reinforced composite sheet preparing unit for heating the laminated composite mat to form foamed cells due to inherent resilience of the reinforcing fiber.

As such, the above fiber fibrillating unit includes a conveying part for conveying fibers to a predetermined position, a fibrillating cylinder for fibrillating the conveyed fibers, a power generating part for rotating the fibrillating cylinder, a sucking part for sucking the fibrillated fibers into a duct, a weighing part for controlling an amount of the fibers to be fed by uniformly dropping the sucked fibers into a dispersing part, and a sensor disposed to the weighing part for sensing the amount of the fibrillated fibers to be fed to feed rollers.

Further, the composite mat preparing unit includes a conveying part for conveying the fibrillated thermoplastic fiber to a predetermined position, a pair of feed rollers for feeding or holding the conveyed thermoplastic fiber, a combining and matting cylinder adjacent to the feed rollers for fibrillating the fibers fed from the feed rollers by rapid rotating speed of needle-distributed rollers, and a walker for increasing a combining ratio of the fibers.

Further, the composite sheet preparing unit includes compression rollers for safely receiving the prepared composite mat, an operation cylinder positioned over the conveying part for conveying the compressed composite mat to a predetermined position, sheet rollers adjacent to the operation cylinder, heating compression rollers for heating and compressing the composite mat having different fiber types passed through a preheating zone, and a cooling/foaming part for cooling and highly foaming the composite mat passed through the compression rollers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a composite mat feeding device of the present invention;

FIG. 2 is a view illustrating an apparatus for manufacturing a fiber-reinforced composite sheet and adiabatic composite sheet of the present invention;

FIG. 3 is a schematic view illustrating a preheating device of the composite mat used in the present invention;

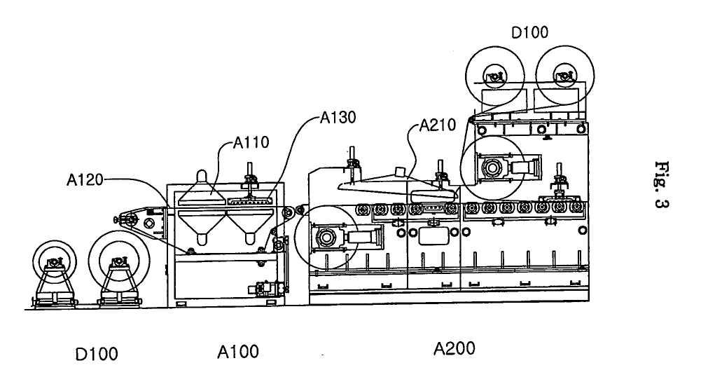

FIG. 4 is a schematic view illustrating a compressing zone used in the present invention;

FIG. 5 is a schematic view illustrating a cooling zone used in the present invention;

FIG. 6 is a schematic view illustrating a pressure controlling unit used in the present invention; and

FIG. 7 is a schematic view illustrating a supplemental device of the present invention.

### BEST MODE FOR CARRYING OUT THE INVENTION

Reference should now be made to the drawings, in which the same reference numerals are used throughout the different drawings to designate the same or similar components.

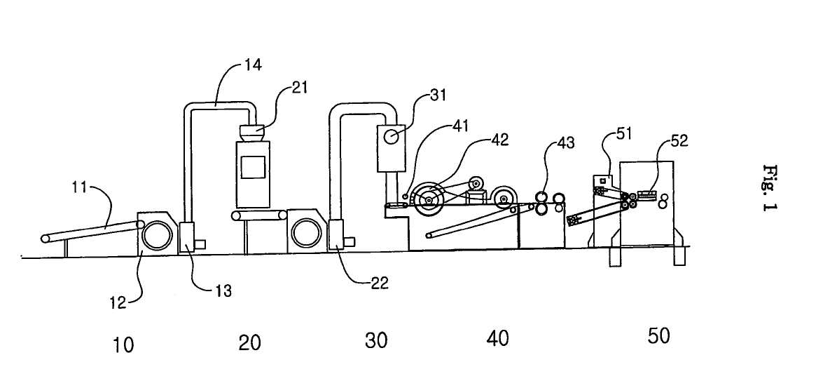

FIG. 1 illustrates a composite mat feeding device according to the present invention. As shown in FIG. 1, the composite mat feeding device includes a fibrillating machine 10, a combining machine 20, a weighing machine 30, a webber machine 40 and a needle-punching machine 50.

In this drawing, the fibrillating machine 10 has a conveying part for conveying fibers to be used to a predetermined position, in which the conveying part includes a conveyor belt 11 for delivering regularly weighed two types of fibers, a fibrillating cylinder 12 for suitably fibrillating the fibers delivered by the conveyor belt 11, a sucking part 13 for smoothly sucking the fibrillated fibers into a duct 14, a dispersing part 21 allowing the fibers sucked into the duct 14 to uniformly drop therein, and a secondary power generating unit and sucking part 22 for feeding the dispersed and dropped fibers to the webber machine 40 defined later.

As such, it is preferred that a predetermined content of cut fibers are used, instead of continuous fibers in the fibrillating machine 10, in view of efficient and continuous feeding of the fiber materials, and reducing production costs of the composite.

In the fibrillating machine 10, the matrix fiber and the reinforcing fiber are loaded in a predetermined weight ratio, and fed to a homogenizing zone for evenly combining the loaded fibers by centrifugal force. Then, the combined fibers are matted, and regular amounts of the matted fibers are conveyed to a feeding part, and the matted fibers are dispersed in the webber machine 40.

Upon fibrillating and matting the fibers in the fibrillating machine 10, the composite fiber mat required per unit area amounts to 0.5-10 kg/min, and preferably 1-6 kg/min. Thus, the preferable amounts of the matted fibers are fed to the webber machine 40.

In the present invention, a conventional stampable sheet manufacturing process is exclusively used in consideration of compatibility with the webber machine 40, in which the two types of fibers exceeding the desired amounts in the weighing machine 30 are automatically introduced into the secondary sucking part 22, thus adding economic benefits and manufacturing convenience.

In order to increase dispersibility of the fibers and to prevent eccentricity thereof in a hopper of the weighing machine 30, strippers 31 are equipped to both sides of an upper end of the hopper having the sucked fibers, and function to classify the sucked fibers. Upon preparation of the composite mat using organic reinforcing fibers, a matting cylinder 42 of the webber machine 40 is rotated at 300-1000 rpm, and functions to simultaneously perform the operations of fibrillating and matting the fibers. However, the melted fiber wastes of the matrix resin are attached to needles distributed in the cylinder 42 at high rotating speed thereof, and thus operation efficiency becomes low, whereby it is difficult to rotate the cylinder at high rotating speeds.

The rotating speed desirable in the matting cylinder 42 ranges from 500 to 800 rpm. In the case of using an inorganic reinforcing fiber, a process of matting the fibers using the rotation speed is more effective. Thus, optimal rotation speed capable of using the organic and inorganic fibers at the same time falls in the range of 800-900 rpm.

With a view to preparation of the composite mat having randomly oriented unidirectional fibers using the composite mat feeding device, the webber machine 40 is additionally mounted to the above feeding device. Thereby, physical properties (tensile strength and impact strength) of composite articles are increased.

In the composite mat feeding device, the conveyed fibers are uniformly dispersed in the hopper through horizontal vibration strippers 31. The fibers may be fed in suitable amounts by an additional sensor mounted to the upper portion of the hopper. Thusly fed fibers are passed through a feeder 41 and then introduced into the matting cylinder 42 capable of rapidly rotating, to form the composite mat having uniform fiber distribution, which is then passed through compression rollers 43 by the conveyor belt and then transferred to the needle-punching machine 50.

The thickness of the mat fed to the needle-punching machine 50 is optionally controlled, depending on rotation frequencies of the matting cylinder 42 and the conveyor belt. The fibers remaining when edges of a fiber-reinforced composite sheet are cut and re-introduced to a secondary fiber feeding unit through a sucking part additionally mounted to lower portions of the rollers 43.

In a case where the fibers are fused to the needles distributed at an inner wall of the rotating cylinder due to friction of tangled fibers at high rotating speeds, uniformity of fiber weight distribution is decreased. Also, upon operation of the cylinder for a long period of time, large quantities of the melted fibers are fused to the needles. The cylinder is again operated after the fused fibers are removed.

Accordingly, the webber machine 40 should be more efficient and suitable for production on large scale, and should easily volatilize the fibers. In addition, when the composite mat fibers combined in the predetermined amounts are provided to the webber machine 40, a weight thereof can be calculated based on the speed of rotation.

At constant speed, the composite mat comprising the state of fiber clumps fibrillated in the webber machine 40 according to the belt velocity are 150-2000 mm thick. When such a composite mat is introduced into the needle-punching machine 50, thickness of the composite mat is too thick to feed. Thus, such a composite mat is passed through the compression rollers 43 and compressed by a belt 51, to reduce the volume of the fiber mat. Then, the fiber mat having reduced volume is easily fed to the needle-punching machine 50.

As for the composite mat for use in preparation of the fiber-reinforced composite sheet and light adiabatic sheet, the fibers should be efficiently combined and uniformly dispersed. For homogeneous dispersion and distribution of the fibers, two composite mat feeding devices and two needle-punching machines are additionally provided. Firstly, the operation of combining and matting the fibers is performed in the cylinder of the composite mat feeding device, and then a homogenized mat having uniformly combined fibers with constant volumes is formed in the needle-punching machine.

In case where the composite mat in the state of fiber clumps is directly fed to a continuous belt, it is difficult to fabricate the uniform composite sheet due to the non-fixed fibers. Thus, in the needle-punching machine 50 capable of fixing the fibers and decreasing the volume thereof, the composite mat in the state of fiber clumps is perforated and punched, whereby the volume of the fiber clumps is decreased and the volume of fiber mat is uniformly controlled. Then, the thusly processed fiber mat is fed to a heating zone. As such, the resin is fixedly set by pressure of the rollers.

The composite fiber mat, which is not passed through the needle-punching machine 50, is in a bulky state, similar to a wad of cotton. Hence, when such a fiber mat is passed through an IR heating plate A130, the mat may damage a heater or may ignite upon coming into contact with the heater. However, by use of the needle-punching machine 50, inherent shrinkage of the fibers is decreased when being passed through the preheating zone and the heating plate, whereby uniformity of the composite sheet is increased. Further, as the volume is decreased, the composite mat does not damage the heater, and risk of ignition by coming into contact with the heater is decreased.

Moreover, the mat is perforated by use of the needles, whereby the volume variation of the composite mat passed through the webber machine 40 is reduced.

As for the needle-punching machine 50, a perforating plate 52 is operated at 500-1000 times/min. Based on characteristics of the fibers, the perforating frequency is optionally set and conveying rates are controlled, resulting in that basic weight and thickness of the composite fiber mat can be easily adjusted.

In the composite mat after being subjected to perforating and punching processes, the perforating frequency affects pore sizes and entanglement of the fibers. For example, as the perforating frequency is increased, the folded fibers may be vertically tangled. Since the composite mat is bonded well, the state of tangled fibers in the composite mat is maintained even though it is fed to the continuous belt.

When a preheating temperature of a preheating chamber which is not shown in the drawing is higher than a glass transition temperature (Tg) of the matrix fiber, crystallinity of the fibers becomes low and the fibers become shrunken. When the perforating frequency is low, the composite mat is less tangled, and thus a fibrillating phenomenon occurs.

However, if the composite mat is rigidly bonded, it is not disturbed even though being compressed by use of the belt 51. Further, as large numbers of pores are present in the mat, warm air can be circulated up to the inside of the mat in the preheating zone. Thus, upon compressing and heating the composite mat, the matrix resin is easily melted and impregnated, to readily form the composite sheet.

Weight and size of the composite fiber mat fed from the webber machine 40 depend on rotation frequencies, types and amounts of the reinforcing fiber. Also, thickness of the composite mat is based on perforating frequency of the perforating plate 52. Stiffness and elasticity of the mat are connected with needle No. of the perforating plate 52.

As such, in order that broken needles are removed in the perforating plate 52, an electromagnet unit having high magnetic strength is equipped to a primary preheating zone A100 to function to remove the broken needles. Thereby, negative effects of such broken needles on quality and safety of the composite sheet and light adiabatic sheet and on operation of a continuous stainless belt are minimized.

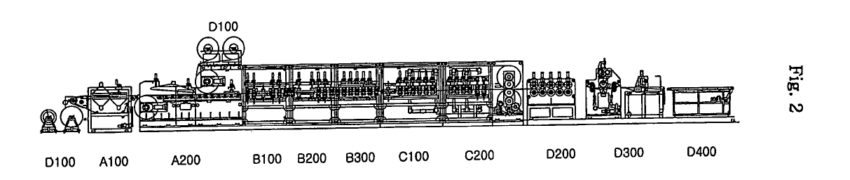

Turning now to FIG. 2, there is shown an overall structure of a manufacturing apparatus of the composite sheet and light adiabatic sheet according to the present invention, in which the light adiabatic sheet is prepared from the composite sheet using inherent resilience of the fiber and is referred to as a pseudo-foamed composite sheet.

The above manufacturing apparatus comprises preheating zones of the composite mat A100 and A200, compressing zones B100, B200 and B300, cooling zones C100 and C200, and other supplemental devices D100, D200, D300 and D400.

The preheating zones are responsible for melting and impregnating the fibers of the composite mat in the belt compressing zones. A device used to remove water and oil contained in the fibers is the primary preheating zone A100, in which heat should be sufficiently transferred up to the inside of the composite mat having a complex structure.

For a more efficient molding process, the composite mat should be sufficiently preheated by the IR heating plate A210 before being subjected to the compressing process. Thereby, a short period of time required to heat the composite mat results in reduced tunnel length.

As mentioned above, the preheating zones can function to transfer heat up to the inside of the composite sheet. Further, a hot air circulation part A110 is used, along with IR system (heating), and uniform heat transfer of the fibers can be accomplished.

Temperatures of heating chamber are generally 80-250° C., but can vary with types of resin fibers used to prepare the composite mat. Water in the composite mat is removed by air preheated to 100-200° C., and water content is in the range of 0.01-0.2%. In addition, the above heat is recovered to a waste heat recovery system through a hot air exhaust duct which is not shown in the drawing, and may be reused later.

The dried composite mat having preheated thermoplastic fiber is passed through upper and lower conveying parts. As such, the used conveyor belt is exemplified by Teflon mesh belt A120 functioning to circulate air using a suction circulation system of air from an upper portion to a lower portion of the belt. In order to prevent micro-fibers from igniting in the preheating device, a filter is used to filter dust and micro-fibers. The rear portion of the composite mat is directly heated by the IR heater.

At high temperatures, an organic matrix fiber present in a surface layer of the composite mat, for example, a polypropylene fiber or a nylon fiber, is melted, parts of which are oxidized, whereby folds of the composite mat are shrunken and the oriented structure of the reinforcing fiber may be broken. Consequently, the composite sheet is degraded in physical properties thereof.

In the present invention, heating time of the IR heater is shortened through efficient energy management and continuous operation. Circulating hot air is blown from the upper portion to the lower portion of the IR heating plate A130 so that the IR heater does not come into contact with dust or micro-fibers. Since the IR heating plate A130 is easily controllable in a position thereof, the upper and lower position of the IR heating plate A130 is adjusted on the basis of thickness of the composite mat. Thereby, heat can be transferred up to the inside of the composite mat, and the high and low position can be increased or decreased according to production rates.

For example, in order to increase productivity, in case of using carbon fiber (CF) having low heat conductivity as the reinforcing fiber in the composite mat, the IR heating plate A130 is positioned to be adjacent to the mat, therefore the mat can be rapidly heated. In such a case, for minimal heat loss, a hot air circulation system is adopted, and the used heat is circulated to the suction duct and reused later.

As such, for ensuring stability of duct operation, a semi-permanent filter mesh is provided to remove short fibers or fine dust contained in hot air passed through the mat.

With the aim of conferring various functions to the composite mat, the surface layer of the composite mat is laminated with a polypropylene film.

Thereby, adhesiveness is increased when a nonwoven fabric or a woven stuff is adhered onto the fiber-reinforced composite for preparation of interior or exterior finishes of automobiles. In addition, patterns or marble materials are formed as a multilayer structure on the surface of the composite mat, and a beautiful surface is provided. Further, a winder Dl00 is mounted to apply various sheets for use in construction materials on the mat.

By use of the manufacturing apparatus of the present invention, thickness of the composite sheet is selectively determined in the range of 0.5-10 mm. Also, manufacturing rates of 0.3-10 m/min are maintained, and the foamed composite sheet can be further prepared.

Meanwhile, the thermoplastic resin used for preparation of the composite sheet is exemplified by polyethylene, polypropylene, polystyrene, polyvinyl chloride, nylon 6, nylon 66, nylon 10, polyamide, vinylon, polyester, or mixtures thereof. Further, plasticizers, thermal stabilizers, light stabilizers, fillers, colorants, pigments, impact improvers, lubricants, etc., may be additionally added to the thermoplastic resin.

As the reinforcing fiber required for preparation of the adiabatic sheet, there are used inorganic fibers, such as glass fiber, carbon fiber, boron fiber etc.; and organic fibers, such as nylon 6, nylon 66, nylon 10, vinylon, aramide, polyester etc. As necessary, these fibers may be used in combinations thereof.

In order that heat transfer is efficiently performed by maintaining heat hysteresis in the present invention, intervals between the rollers are optionally controlled as shown in Table 1, later herein. While the thermoplastic fiber as the matrix resin comes into contact with the stainless continuous belt heated to about 200° C., heat hysteresis factor of the melted thermoplastic resin is changed in a direction perpendicular to a melt flow direction, whereby the melted thermoplastic resin can be impregnated up to the inside of the composite mat.

While the melted thermoplastic resin is impregnated to the tangled fiber reinforcement, wetness of resin on a surface of the reinforcement is increased. Further, since the resin is impregnated up to the inside of the composite mat, the fiber-reinforced composite having high strength can be manufactured.

Using resilience of the reinforcing fiber, the foamed fiber-reinforced composite may be manufactured. That is, the thermoplastic matrix fiber and the fiber reinforcement are combined and volatilized in the matting cylinder to tangle two types of the fibers, whereby the oriented structure of the fibers is maintained in three-dimensional structure. The combined composite mat is fixed while being perforated by the distributed needles, and has a predetermined thickness. While the intervals between the rollers are gradually decreased, pressure applied to the continuous belt from the rollers is maintained. Thereby, the matrix resin is melted and impregnated in the composite mat. As such, when the pressure is instantaneously removed from the reinforcing fiber which is compressed to the belt, the tangled reinforcing fiber is foamed similarly to chemically foamed materials, attributable to inherent resilience of the reinforcing fiber, to manufacture the pseudo-foamed fiber-reinforced composite sheet.

The foamed composite is prepared to a final sheet thickness of 3-20 mm, with a specific gravity of 0.5-0.9 g/cm³, and eventually is used as a light adiabatic sheet. For example, before being introduced into the primary compressing zone B100, the composite mat matted in the webber machine 40 is 250 mm thick. After being compressed by the rollers, the thickness of the composite mat is further decreased to about 50 mm by use of the needle-punching machine 50. When such 50 mm thick mat is compressed, 30 bar or greater is applied to the belt. Whenever the thickness is reduced by 10% according to initial thickness variations, pressure of 1 bar or less is further required.

When the polypropylene resin as the matrix resin of the composite mat is not melted, thickness control is difficult to perform. Thus, high pressure is applied to the belt and then to the rollers in a continuous process.

The compressing zones function to control the applied pressure, to which a slide block B160 is mounted to maintain a constant pressure, thereby easily performing vertical operation of the compressing zone B100. Upon such vertical operation, springs are mounted to a height controlling portion as well as the slide block B160 so that the constant pressure is applied to the belt. Initial pressure is set to about 60 kg/cm². When the pressure is higher than the initial pressure, there are occasions when the mat is thick.

The thickness are adjusted by tension of the spring. Tension of the spring according to compression changes depends on compressing conditions, which are shown in Table 1, below.

TABLE 1
Relation of Thickness and Spring Tension
(Final Thickness: 3 mm)

| | Pre- | 1^{st} | | 2^{nd} | | | 3^{rd} | | | 1^{st} | | 2^{nd} | |
|---|---|---|---|---|---|---|---|---|---|---|---|---|---|
| | heating | Compress. | | Compress. | | | Compress. | | | Cooling | | Cooling | |
| | Zone | Zone | | Zone | | | Zone | | | Zone | | Zone | |
| Thick.(mm) | 50 | 35 | 13 | 11 | 9 | 5 | 3.5 | 3.3 | 3.2 | 3.15 | 3.1 | 3.05 | 3.0 ± 0.2 |

| Spring | | 60 | 150 | 200 | 150 | | 150 | |
|---|---|---|---|---|---|---|---|---|
| (kgf/cm²) | | | | | | | | |
| Belt Surface(° C.) | 200 | 230 | 230 | 220 | 150 | 90 | 70 | 50 |

*process condition of PP/PET

The surface of the belt is compressed by the rollers which are applied with tension of the spring. Upon compressing by use of the spring tension, the composite mat is differently melted according to temperatures of the surface of the belt.

When the compressing process is performed at the belt temperature of 220° C., the composite mat has a thickness much thinner than the initial thickness thereof. If the non-melted matrix fiber and reinforcing fiber are used in large amounts, thickness variations become low. When the thickness of the mat exceeds the interval between the rollers, the mat is subjected to high spring tension.

As such, when the pressure of the spring is set to a predetermined level, the belt is not freely movable. Thus, the compressing force is slightly decreased in consideration of belt velocity and melting rates of the melt resin in the composite mat. Continuous compression of the belt is achieved with a designed roller system, and a structure of the pressure unit is re-designed in consideration of pressure distribution.

For instance, a cotton plate is compressed using a rod bar type pressure unit at high pressures. While, in case of melting the thermoplastic resin, the compression system by the roller is preferably adopted at relatively low pressures.

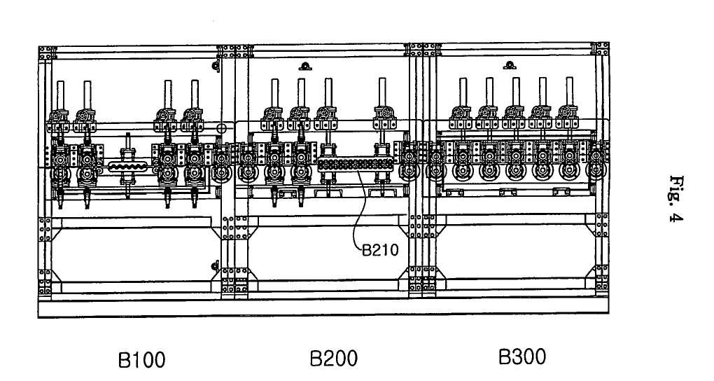

Turning now to FIG. 4, the compressing zones used in the present invention are schematically illustrated.

As shown in FIG. 4, while the composite mat passed through the primary compressing zone B100 is maintained in a predetermined thickness by use of the compression rollers, heat of the belt is transferred to the composite mat. In a secondary compressing zone B200, the thermoplastic resin fiber as the matrix resin is melted and impregnated into the reinforcing fiber.

In the secondary compressing zone B200, the compression rollers and the IR heating plate B210 are provided in the form of a linear arrangement. The matrix resin should be completely impregnated into the reinforcing fiber at high temperatures in the secondary zone B200. In addition, in a tertiary compressing zone B300, while the temperature condition is maintained as in the secondary compressing zone B200, the pressure condition is further provided. Thereby, the composite mat is minimized in porosity or the thermoplastic resin is sufficiently impregnated and wetted. When the mat is cooled through a thickness controlling part, the composite sheet having high performance can be prepared. Further, the composite sheet is re-heated and intervals between rollers of cooling zones C100 and C200 are broadened. As such, attributable to inherent resilience of the reinforcing fiber, the pseudo-foamed light adiabatic sheet having high performance can be prepared.

On the other hand, in the case where fibers are used as a reinforcement in conventional fiber-reinforced composites, short fibers having a length of ones to 25 mm have been used. However, short reinforcing fibers result in ineffective stress transfer under a predetermined stress, thereby obtaining poor reinforcing effect.

With the intention of increasing reinforcing effects, long fibers are preferably used as the reinforcing fiber, instead of short fibers. As such, long fibers have a length of 30 mm or longer, especially 50 mm or longer. Fiber length depends on types of composite materials or purposes thereof.

According to the length of the fibers, the composite materials exhibit different physical properties, such as stiffness, dimensional stability and heat resistance. Also, the above properties are affected by the amounts of filled fibers, length of molded fibers, dispersed state and oriented state of the fibers. Conventionally, fiber-reinforced composites have randomly dispersed fiber reinforcements, and thus distribution of the reinforcing fiber is randomly dispersed in only a horizontal direction. Thus, impact strength of the conventional composites is beyond the desired level. However, in the present invention, since the reinforcing fiber is randomly oriented by means of the composite mat feeding device using centrifugal force, the reinforcing fiber is strongly coiled to exhibit three-dimensional weaving effects.

That is, there are proposed methods exhibiting weaving effects using a similar technique to weaving, because the method of preparing the fiber-reinforced composites by direct weaving is very low in productivity. Conventionally, when the reinforcing fiber is randomly oriented in the matrix resin, the fiber is formed in a horizontal direction. Thus the fiber has no vertical orientation, and strength is thus limitedly exhibited. Whereas, in the present invention, both of the matrix and the reinforcement are used as a fibrous phase and combined using centrifugal force, and thus the fibers are coiled in a horizontal direction. As well, 10-20% of the fibers are coiled in the vertical direction, to form a three-dimensional dynamic structure. Thereby, the fiber-reinforced composite exhibits high strength and high tension.

Physical properties of the composite are considerably affected by characteristics of the matrix and the reinforcements as well as adhesion between the matrix and the reinforcing fiber, that is, interface properties. The interface of the composite material functions to transfer stress or variation of external impact energy from the matrix to the fiber. Thus, the properties of the interface are more important.

The prepared composite sheet is re-heated (heating temperature 240° C. or higher), and the resin therein is melted, expanded and cooled to form the foamed composite sheet. In the composite mat used for the molding process, the inorganic reinforcing fiber having a large restoring force is contained in the amount of 20-40 vol %, and the organic reinforcing fiber is contained in the amount of 30 vol % or more.

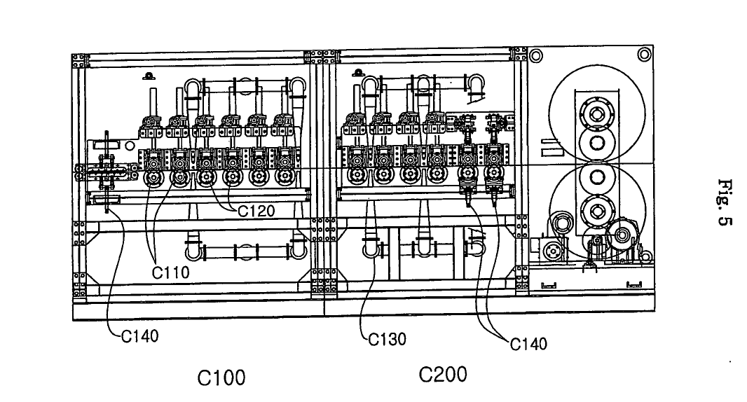

FIG. 5 schematically illustrates the cooling zones used in the present invention.

As shown in FIG. 5, the cooling zones C100 and C200 comprise magnet rollers C110 cooled for foaming the composite mat, cooling rollers C120, an air cooler C130 and IR heater tunnels C140.

The composite sheet is prepared by passing through a secondary cooling zone C200, while the foamed light adiabatic sheet is obtained when the intervals between the magnet rollers C110 exceed the thickness suitable for a like foaming process by inherent resilience of the reinforcing fiber.

For example, since resilience of polypropylene (PP) fiber is low and carbon fiber (CF) and glass fiber (GF) have high resilient modulus, entanglement of the mutually combined fibers leads to increased resilience required to foam the composite sheet. Upon preparation of the light adiabatic sheet foamed using organic reinforcing fiber, it is apparent that optimal sheet appearance is realized by foaming conditions and suitable amounts of the foaming agent such as the reinforcing fiber.

In order to perform the foaming process, the composite mat passed through the IR heater tunnels C140 should be sufficiently preheated up to the inside thereof. Upon the foaming process, the fibers are expanded and foamed by inherent resilience thereof. Thereby, the foamed cells have a small size, and uniform distribution thereof can be maintained.

In case of not using the preheating process, the melting, heating and compressing processes of the composite mat are performed for a relatively long period of time. Thus, in order to increase the foaming efficiency, the compression belt should be set to a relatively high temperature. When the surface temperature of the belt is increased, the carbon fiber and glass fiber combined with the polypropylene fiber are foamed by inherent resilience thereof, whereby the foaming process is naturally performed. However, since the polypropylene fiber as the matrix resin is processed to the temperature higher than the melting temperature thereof, it is deteriorated. Thus, strength of the matrix becomes low, and the resultant foamed composite sheet does not meet the demands for a desirable adiabatic sheet.

When being cooled, the foamed adiabatic composite having thermal conductivity is easily cooled at a surface layer thereof, but a period of time required to cool a core layer thereof is considerably long, due to different cooling rates depending on thickness of the foamed layer.

In typical, the rollers exhibit a cooling function by use of cooling water fed externally. However, cooling efficiency is low because a surface of the roller coming into contact with the belt is small. Therefore, the adiabatic sheet is difficult to maintain as a sheet form. Thus, in the present invention, a process of rapidly decreasing the belt temperature is adopted.

In such a case, when the belt temperature is drastically decreased, the composite mat may be damaged due to different thermal expansion coefficients between the surface layer and the core layer thereof, therefore resulting in that physical strength, such as impact strength, of the mat is lowered. Accordingly, it is noted that the belt surface is cooled by means of a natural air circulation system.

That is, upon rapid cooling of the belt, the composite mat is degraded in its physical properties along fine cracks formed due to the different thermal expansion coefficients. Thus, with the aim of cooling the belt at a constant rate, cooling air circulation system is employed.

Moreover, the cooling rate is related to a production rate of the fiber-reinforced composite. That is, adiabatic properties of the fiber-reinforced composite are based on reinforcing fiber materials, and the total length of the cooling zones is in proportion to the adiabatic properties. Hence, 3-5 air circulation coolers C130 are provided in consideration of cooling efficiency.

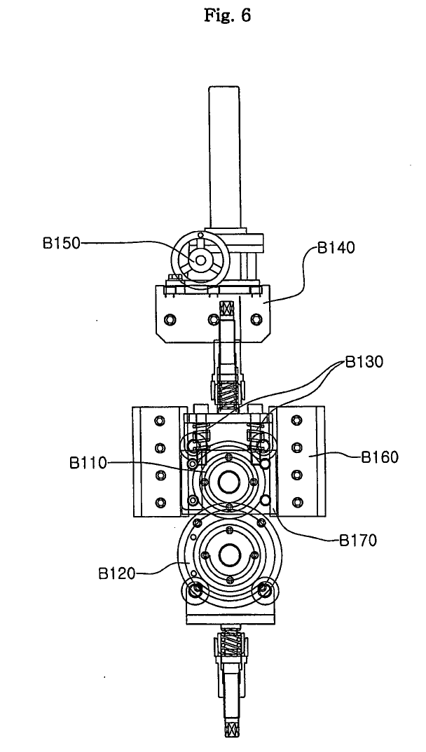

FIG. 6 schematically illustrates the pressure controlling unit used in the present invention.

As shown in FIG. 6, the primary compressing zone B100 comprises upper and lower rollers B110 and B120, springs B130, a height controlling part B140, a warm gear B150, a slide block B160 and a slide B170. The upper roller B110 offsets vertical operations and rocking vibrations in the slide block B160. The springs B130 are mounted to apply constant tension to the rollers. Further, a controller is separately provided to apply a proper pressure to the rollers by the pressure of the springs B130.

Two springs B130 are equipped to the left and right of each upper roller B110 so as to prevent horizontal vibration of the rollers B110 and to ensure satisfactory operation thereof when being subjected to overload. When the tension of the springs B130 is represented by an integer value or more, pressure higher than a predetermined level is set to be applied to the belt.

Tension of the two springs B130, represented by constant values by means of a torquemeter, is set to a predetermined level. The tension is set as in the above Table 1 according to positions of the pressure unit, and the set values are different based on various materials.

The thickness of the composite mat differs at positions, but thickness thereof may be controlled by compressing the belt under tension of the springs B130 and melting the composite mat. The thermoplastic resin fiber as the matrix resin of the composite mat is contained in the amount of 60 wt % or more in the mat. Upon compressing the mat by tension of the springs B130, the melted resin is dispersed and impregnated, and thus a desired thickness and weight distribution is maintained. Under overloads having larger variations, tension of the springs B130 is only increased by thickness variations.

For example, in case of normal state, 10 mm thickness of the composite mat corresponds to 60 kg/cm² of the spring pressure applied to the belt. In addition, 10.5 mm thickness of the mat increased by 0.5 mm due to thickness variations corresponds to about 80 kg/cm² of the spring pressure applied to the belt.

When high pressure is applied to the belt, the matrix resin melted adjacent to the surface of the belt is impregnated into the composite mat. As such, it can be confirmed that the springs are decreased in length thereof. Through compressing process of the rollers, the matrix resin is easily melted and impregnated in a direction opposite to a conveying direction of the belt.

At high pressure of 150 kg/cm², the fibers may be arranged in a direction opposite to the conveying direction of the belt or the conveying operation of the fibers may be disturbed. In such a case, the bearing blocks are formed as a slidable type and thus the conveying operation becomes easy.

To meet such conditions, intervals between the rollers in the primary compressing zone B100 are adjusted as in the above Table 1. The thickness of the composite mat is controlled according to the surface temperature of the belt, compression pressure and pressure required to melt and impregnate the mat.

When the composite mat fixed by the rollers in the compressing zone is subjected to a pressure reducing thickness thereof, the spring tension of the slide block B160 provided in each roller is applied to the mat. Thereby, smoothness as well as thickness of the composite mat are constantly maintained.

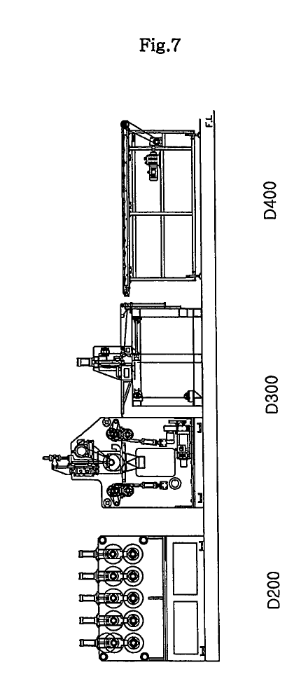

FIG. 7 schematically illustrates various supplemental devices of the present invention. The winder D100, which is represented in FIG. 2 as the supplemental device, functions to superimpose a laminate film or a nonwoven fabric on the composite mat. As shown in FIG. 7, cooling rollers D200 function to confer stability to the cooled composite mat and to easily cut the composite mat by cooling. Further, a cutting unit D300 capable of cutting the mat to a predetermined size, and a conveying unit D400 capable of conveying the cut composite sheet, are provided.

### INDUSTRIAL APPLICABILITY

As described above, the present invention provides a method of manufacturing a fiber-reinforced composite using a composite fiber mat and an apparatus for manufacturing the fiber-reinforced composite. In the present invention, a thermoplastic fiber is used as a matrix of the composite, instead of powder to pellet type thermoplastic resin. Such a thermoplastic fiber is combined and matted with a reinforcing fiber at high rotating speeds, to prepare the composite mat. Even after the mat is stored or conveyed, it can be molded to a fiber-reinforced composite sheet at any time. In addition, the fiber-reinforced composite sheet of the present invention, obtained by molding the composite mat having uniformly dispersed fibers, is superior in interfacial adhesion due to uniform adhesiveness between the reinforcing fiber and the matrix resin. Consequently, the fiber-reinforced composite having high strength can be manufactured.

Further, both of a reinforcement and the matrix are of a fibrous phase. Thus, when the reinforcing fiber is combined with the matrix fiber at high rotating speeds by use of the composite mat feeding device, fibers are self-supported and have similar orientation to three-dimensional structure. Accordingly, the composite sheet made of the composite mat is enhanced in impact resistance. Also, since the fibrous phase is simultaneously used as the matrix and the reinforcement, the dispersed state of the fibrous phase matrix in the prepared composite mat is good. As well, physical properties of initially dispersed fibers are maintained as they are. Thus, the composite mat is easily handled. While being melted, the thermoplastic micro-fiber is mutually adhered to the reinforcing fibers, thereby increasing interfacial adhesion and reinforcing strength.

The thermoplastic resin fiber as the matrix resin and the reinforcing fiber are used to prepare the composite mat, which is formed to the fiber-reinforced composite sheet using the manufacturing apparatus thereof. The composite sheet is laminated with a layering sheet such as a laminate film or unidirectional reinforcing fiber, to obtain the fiber-reinforced composite having enhanced performance. In addition, upon manufacturing the composite sheet, the composite sheet is expanded by inherent resilience thereof while being compressed by the rollers, thereby obtaining a foamed light adiabatic composite sheet having excellent adiabatic property and uniform size and distribution of foamed cells.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of manufacturing a fiber-reinforced composite having high strength by heating and extruding a composite mat comprising a thermoplastic fiber as a matrix resin and a reinforcing fiber combined and matted together, the method comprising the following steps of:
fibrillating and combining the thermoplastic fiber and the reinforcing fiber, to form the composite mat;
dispersing and volatilizing the composite mat; and
needle-punching the dispersed and volatilized composite mat to increase dispersibility of the reinforcing fiber in the mat and to maintain a coiled fiber shape and three-dimensional structure of the fiber in the mat, provided that orientation of the reinforcing fiber in the mat is fixed.

2. The method as defined in claim 1, further comprising the step of subjecting the composite mat after the needle-punching step to preheating in a preheating zone, melting, compressing and molding in a compressing zone, and cooling in a cooling zone, to obtain a composite sheet.

3. The method as defined in claim 2, further comprising the step of re-heating the composite sheet passed through the compressing zone to increase thickness and width thereof, thereby obtaining a pseudo-foamed composite sheet by inherent resilience of the reinforcing fiber.

4. The method as defined in claim 3, wherein the thickness and width of the composite mat are increased by a continuous stainless belt and a magnet roller.

5. An apparatus for manufacturing a fiber-reinforced composite having high strength, comprising:
a fibrillating and combining unit of a thermoplastic fiber as a matrix resin and a reinforcing fiber to form a composite mat;
a dispersing and volatilizing unit of the composite mat; and
a needle-punching unit of the dispersed and volatilized composite mat to increase dispersibility of the reinforcing fiber in the mat and to maintain a coiled fiber shape and three-dimensional structure of the fiber in the mat, provided that orientation of the reinforcing fiber in the mat is fixed.

6. The apparatus as defined in claim 5, further comprising:
a pair of upper and lower rollers for melting, compressing and molding the composite mat passed through the needle-punching unit, conveyed by a continuous stainless belt; and
a pressure controlling unit having a spring unit for heating and compressing the rollers so that the thermoplastic resin fiber is melted and the melted thermoplastic resin fiber is impregnated into the reinforcing fiber by the rollers, and for preventing overload of the rollers when the thermoplastic resin fiber is not melted.
